(19) United States
(12) Patent Application Publication
(10) Pub. No.: US 2005/0120634 A1
(43) Pub. Date: Jun. 9, 2005

(54) Method of manufacturing a sealing gasket, in particular a window run for a motor vehicle, and to a gasket manufactured in this way

(75) Inventors: Stephane Drivon, Chalette Sur Loing (FR); Emmanuelle Moisy, Montargis (FR); Bertrand Florentz, Paucourt (FR)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Hutchinson

(21) Appl. No.: 11/008,497

(22) Filed: Dec. 9, 2004

(30) Foreign Application Priority Data
Dec. 9, 2003 (FR) 0314406

(51) Int. Cl. B32B 31/00; E06B 7/00

(52) U.S. Cl. 49/475.1; 156/85; 156/244.24; 156/244.25; 428/122

(57) ABSTRACT

The invention relates to a method of manufacturing a sealing gasket, in particular a hidden frame type window run for a motor vehicle, the method consisting in placing in the gasket that is made from thermoplastic materials, at least one anti-shrinkage element that is placed in a position that is determined so as to obtain automatically and naturally a gasket that is curved after it has been extruded and has cooled down, and the method further consisting in acting on the shrinkage ability of the materials constituting the gasket in order to obtain varying amounts of curvature.

The invention relates to a method of manufacturing a sealing gasket, in particular a window run for a motor vehicle, and to a gasket manufactured in this way.

### BACKGROUND OF THE INVENTION

In general, three major families of window runs or gaskets can be distinguished, e.g. for providing sealing between a window and the window frame of a motor vehicle door, namely: channel-section runs; single-rabbet runs; and hidden frame runs. Hidden frame runs present a mounting clip of U-shaped right section which fits over the window frame of the door and which comprises a metal strength member for strengthening the clip, two asymmetrical legs fitted with sealing lips, and one or two additional lips providing two sealing functions.

Such a window run or gasket is made of rubber, being manufactured by extrusion, and after being extruded and cooling down, it presents flexibility enabling it to be deformed so as to fit the shape of the window frame of the door onto which it is engaged. Although such window gaskets provide satisfactory performance, they nevertheless present drawbacks of weight and cost.

In order to reduce the weight and the cost of such gaskets, it is advantageous to make them out of thermoplastic materials (thermoplastic elastomer (TPE), thermoplastic olefins (TPO), polypropylene, for example). Nevertheless, under such circumstances, it becomes very difficult, if not impossible, to mount the gasket on a motor vehicle door insofar as the rigidity of thermoplastic materials, and in particular polypropylene for example, does not enable the gasket to match the shape of the door without deforming said gasket in harmful manner, e.g. forming wrinkles or folds.

### OBJECTS AND SUMMARY OF THE INVENTION

An object of the invention is to mitigate the above-mentioned drawbacks and to propose a novel method of manufacturing such gaskets which enables gaskets to be obtained after extrusion and cooling that are automatically and naturally curved.

To this end, the invention provides a method of manufacturing a sealing gasket, in particular a hidden frame type window run for a motor vehicle, the method consisting in placing in the gasket that is made from thermoplastic materials, at least one anti-shrinkage element that is placed in a position that is determined so as to obtain automatically and naturally a gasket that is curved after it has been extruded and has cooled down, and the method further consisting in acting on the shrinkage ability of the materials constituting the gasket in order to obtain varying amounts of curvature.

Advantageously, the anti-shrinkage element is positioned in the gasket in such a manner as to obtain curvature automatically in at least two different planes.

By making the sealing gasket out of thermoplastic materials, it is possible to reduce the cost and the weight thereof, but with the drawback that once cooled after being extruded it presents a shape that is substantially rectilinear and more rigid than a gasket made of rubber. However, the anti-shrinkage element placed in the gasket can enable the lack of gasket flexibility to be compensated because, depending on its position, it makes it possible to obtain automatic and natural curving of the gasket which can be optimized as a function of the shrinkage ability of the materials constituting the gasket.

In general, a sealing gasket forming a hidden frame type window run, for example, presents a mounting clip of U-shaped right section with first and second limbs that are parallel to each other, a main leg and a secondary leg which extend perpendicularly to the second limb of the clip, and sealing lips towards the ends of said legs.

In the method of the invention, the anti-shrinkage element is placed in the clip of the gasket, and the thermoplastic materials used for manufacturing the gasket preferably have a decreasing shrinkage gradient going from the clip towards the sealing lips, and, for example, polypropylene is used to make the clip, a TPO for making the main leg, and a TPE for making the sealing lips.

The anti-shrinkage element may be constituted by a reinforcing member or at least one metal wire or glass fiber, for example.

The invention also provides a sealing gasket, in particular of the hidden frame run type, in which the anti-shrinkage element is positioned in the first limb of the clip to provide a top segment for the run, and in which the anti-shrinkage element is positioned in the web of the clip to constitute a vertical segment of the run.

### BRIEF DESCRIPTION OF THE DRAWINGS

Other advantages, characteristics, and details of the invention appear from the additional description below made with reference to the accompanying drawings, given purely as examples, and in which:

FIG. 1 is a section view of a sealing gasket forming the top segment of a hidden frame type run of the above-mentioned prior art type;

FIGS. 2a, 2b, and 2c are diagrammatic side views for showing respectively a front door and a back door of a “Sedan” type vehicle, and a front door of a “people carrier” type vehicle;

FIG. 3 is a section view of an embodiment of the invention showing a top segment for a hidden frame type run;

FIG. 4 is a top view of a vehicle having doors whose window frames curve in two different planes;

FIG. 5 is a section view of another embodiment of the invention showing the top segment of a hidden frame type run;

FIG. 6 is a section view of an embodiment of the invention showing a vertical segment of a run;

FIG. 7 is a section view of another embodiment of a vertical segment of a hidden frame type run;

FIGS. 8 and 9 are views of two other embodiments of the invention showing a top segment and a vertical segment of a hidden frame type run; and

FIG. 10 is a section view of another embodiment of the invention showing a single rabbet type run.

### MORE DETAILED DESCRIPTION

The window gasket 1 shown in FIG. 1 shows the prior art mentioned in the introduction. The gasket 1 forms a top segment of a window run, and comprises a mounting clip 3 of U-shaped right section in which there is embedded metal reinforcement 4 also of U-shaped right section, two asymmetrical legs 5 and 6 constituting respectively a main leg and a secondary leg which project at substantially 900 from one of the limbs 3a of the mounting clip 3 and which terminate in sealing lips 9 suitable for coming into sliding contact with both faces of a window V. The other limb 3b of the mounting clip 3 supports sealing lips 9a suitable for coming into contact with the body of the vehicle.

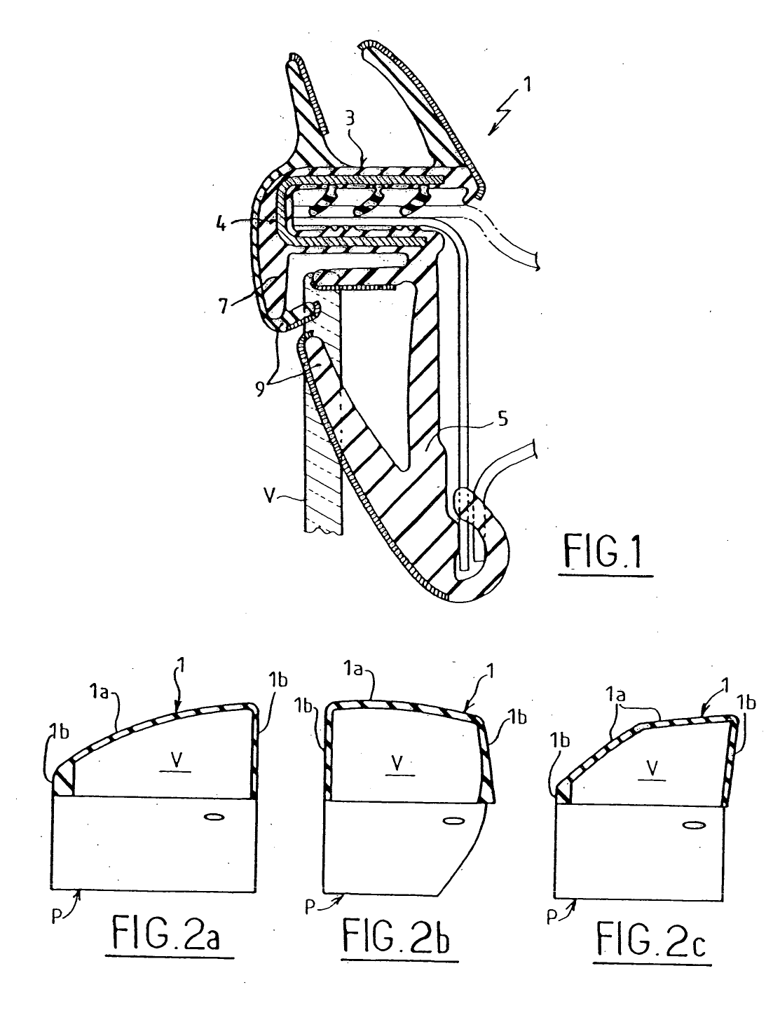

FIGS. 2a, 2b, and 2c are diagrams showing various different doors P for motor vehicles, showing the general shapes of the window gaskets that form window runs. FIG. 2a shows a front door P of a “Sedan” type car, with the top segment 1a of the run 1 presenting considerable curvature, whereas its curvature is small in FIG. 2b which shows a back door P for a “Sedan” type car, or else there may be two lightly curved portions as shown in FIG. 2c which shows a front door P of a “people carrier” type car. The vertical side segment 1b for each of the runs 1 are secured to the top segment 1a by conventional junction molding, and similarly the two portions of the top segment 1a shown in FIG. 2c are joined to each other by junction molding.

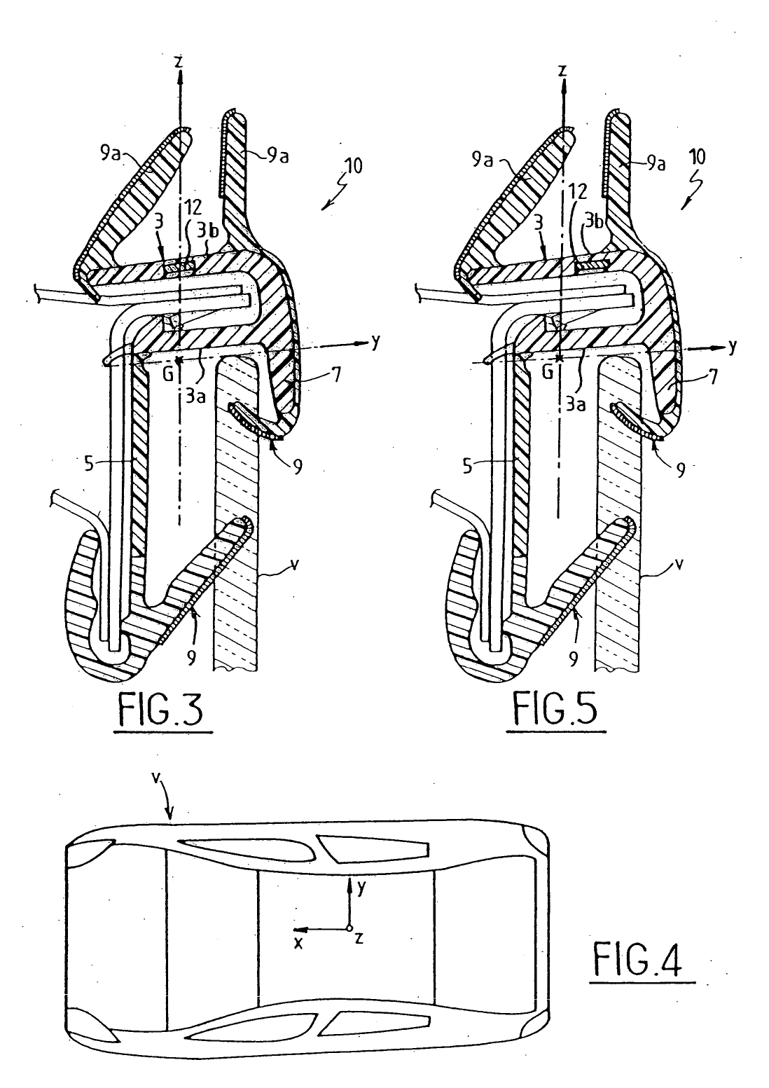

In the examples shown in FIGS. 2a, 2b, and 2c, the curves of the top segments of the runs lie in a plane XOZ, and to obtain the curves automatically and naturally, the invention proposes using a gasket of the kind shown in FIG. 3 which is manufactured from various different thermoplastic materials having different shrinkage properties.

More precisely, the gasket 10 presents a structure similar to that of the gasket shown in FIG. 1, but made out of thermoplastic materials, together with the presence of an anti-shrinkage element 12 in the form, for example, of reinforcement or at least a metal wire or a glass fiber, which element, depending on its position in the gasket 10, serves to obtain a gasket 10 that curves naturally and automatically in at least one plane in order to compensate for the lack of flexibility of the gasket 10 made out of thermoplastic materials, and make it easier to mount on the window frame of the vehicle door.

By way of example, with a gasket 10 of the kind shown in FIG. 3, constituting a top segment for a hidden frame type run, the anti-shrinkage element 12 is placed in the limb 3b of the clip remote from the two legs 5 and 7, and is generally situated in or on either side of a vertical plane containing the center of gravity G of the gasket when considering the right section thereof. This position of the anti-shrinkage element 12 enables a gasket that is curved in the XOZ plane to be obtained automatically after extrusion and cooling.

In order to control the curvature of the curved gasket, action is taken on the shrinkage ability of the thermoplastic materials used for making the gasket, it being understood that it is necessary to have a shrinkage gradient that increases going away from the neutral fiber of the gasket which is formed by the anti-shrinkage element 12. For this purpose, and by way of example, the clip 3 of the gasket 10 is made of polypropylene which is a material that shrinks little, the main leg 5 of the gasket 10 is made of a TPO that shrinks somewhat more, and the main sealing lip 9 at the end of the main leg 5 is made of a TPE that shrinks even more. The secondary leg 7 of the gasket is considerably shorter than the main leg 5 and can be made out of the same material as the clip 3. In a variant, the clip can be made of a material such as polypropylene, and the main leg 5 and the sealing lip 9 can be made of TPE, for example.

Such a gasket 10 can be used to make the top segment 1a of the run 1 shown in FIG. 2a which presents a relatively large amount of curvature.

However, to make the top segment 1a of the run 1 shown in FIG. 2b or the two portions of the top segment 1a of the run shown in FIG. 2c all of which are of small curvature, the position of the anti-shrinkage element 12 is not changed, but the main leg 5 of the gasket is made of a thermoplastic material having smaller shrinkage ability than a TPO. For example, it is possible to use the same material as that constituting the clip 3, i.e. polypropylene.

With reference to FIG. 4, the window frames of the door of the motor vehicle V may be curved not only in the XOZ plane, but also in the XOY plane. In order to make it easier to mount the gasket 10 and also obtain curvature in the XOY plane, it suffices to offset the anti-shrinkage element 12 to the right in the limb 3b of the clip, as shown in FIG. 5.

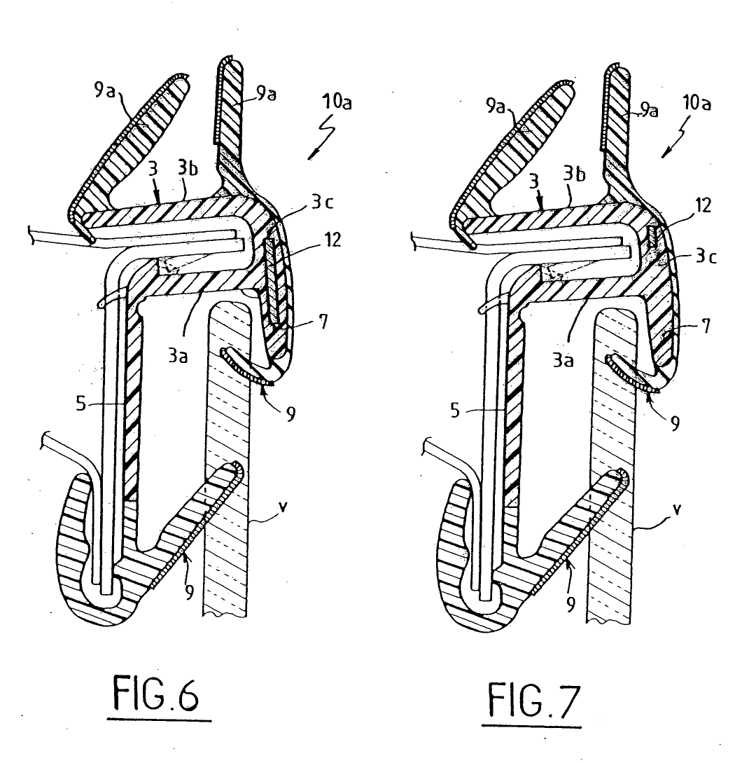

With reference to a vertical segment 10a of the run 10, this segment may present curvature solely in the YOZ plane. Under such circumstances, as shown in FIG. 6, the anti-shrinkage element 12 is positioned in part in the web 3c of the clip 3 and in part in the secondary leg 7 of the vertical segment 10a. This anti-shrinkage element 12 may be constituted by a relatively wide piece of reinforcement presenting a large second moment of area in the XOZ plane so as to prevent material shrinking in said plane, while encouraging material to shrink in the YOZ plane so as to obtain curvature in said plane.

However, if the shape of the door requires curvature both in the YOZ plane and in the XOZ plane, then the anti-shrinkage element 12 is narrower so as to lie solely in the web 3c of the clip, as shown in FIG. 7. It may be constituted by at least one metal wire or glass fiber, for example, so as to present a small second moment of area, thereby encouraging shrinkage of the materials.

For a vertical segment 10a of a run of the kind shown in FIGS. 6 and 7, the thermoplastic materials used can be, for example: polypropylene for the clip 3 and the legs 5 and 7, and a TPE for the lip 9 situated towards the end of the main leg 5. In a variant, the clip can be made of a material such as polypropylene while the main leg 5 and the sealing lip 9 are made of TPE, for example. Naturally, the thermoplastic materials used may be different from those mentioned above, but there is preferably a shrinkage gradient in the materials that decreases going from the clip 3 towards the sealing lip 9 situated towards the end of the main leg 5, so that the materials situated furthest from the anti-shrinkage element 12 shrink the most.

In general, it is advantageous for the anti-shrinkage element to be covered in an adhesion promoter to ensure that it bonds well with the material coating it.

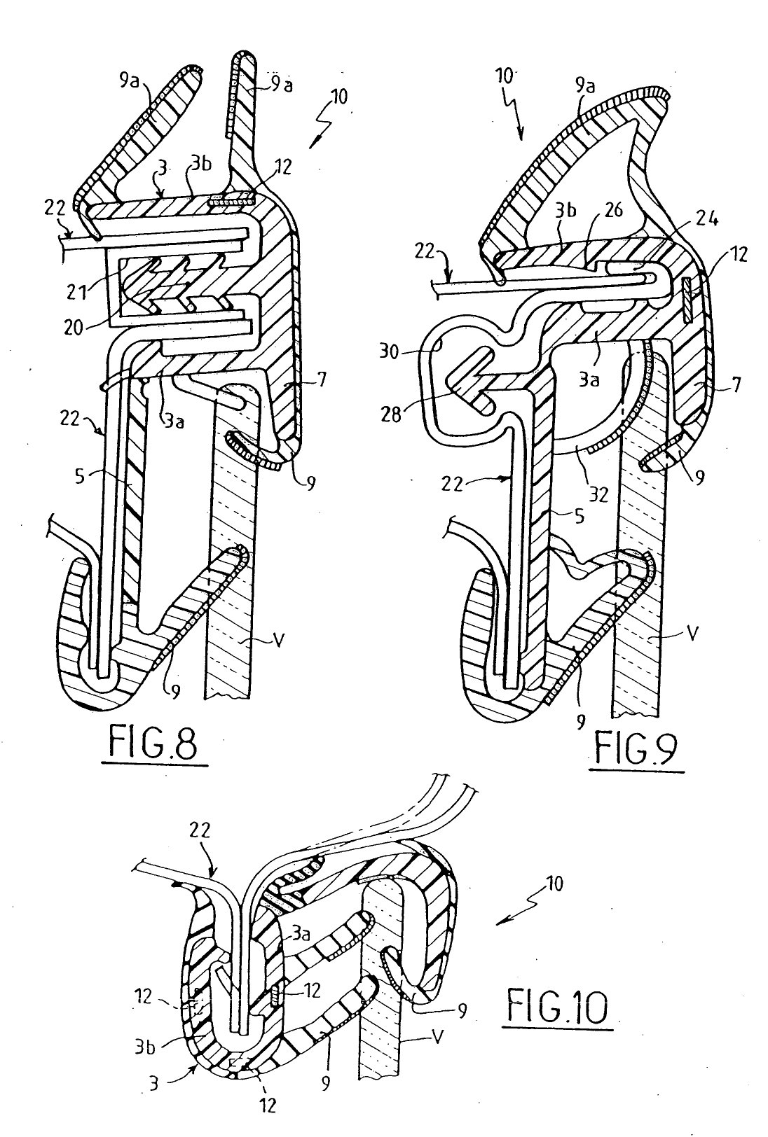

In a preferred embodiment, shown in FIG. 8, which is a variant of the embodiment shown in FIG. 5, the clip 3 is replaced by a central barbed member 20 which is anchored in a housing 21 in the rabbet 22 and is itself of generally U-shaped right section.

In the embodiment shown in FIG. 9, which is a variant of the embodiment shown in FIG. 7, the following differences should be observed:
the sealing lip 9 situated at the end of the main leg 5 of the gasket is folded over the rabbet 22 beside the window V so as to form a tubular element, and the two sealing lips 9a which extend from the limb 3b of the gasket are united so as to likewise form a tubular element;
the rabbet 22 of the door presents a crimped portion 24 on top and the clip 3 which is mounted thereon presents a free end that is retained by an internal projection 26 projecting from the inside face of the limb 3b of the clip 3;
the gasket is also held in the rabbet 22 by a barbed member 28 that is anchored in a housing 30 in the rabbet 22; and
a tubular type lip 32 is provided between the leg 5 and the lip 3a of the clip 3 that is to come into contact with the top portion of the window V.

Finally, the embodiment shown in FIG. 10 shows a sealing gasket of the invention, but for a gasket for a single-rabbet window run.

1. A method of manufacturing a sealing gasket, in particular a hidden frame type window run for a motor vehicle, the method consisting in placing in the gasket that is made from thermoplastic materials, at least one anti-shrinkage element that is placed in a position that is determined so as to obtain automatically and naturally a gasket that is curved after it has been extruded and has cooled down, and the method further consisting in acting on the shrinkage ability of the materials constituting the gasket in order to obtain varying amounts of curvature.

2. A method according to claim 1, in which the anti-shrinkage element is positioned in the gasket in such a manner as to obtain curvature automatically in at least two different planes.

3. A method according to claim 1, in which the gasket presents a mounting clip of U-shaped right section having first and second mutually parallel limbs, a main leg and a secondary leg which extend perpendicularly from the second limb of the clip, and sealing lips towards the ends of said legs, where the method consists in placing the anti-shrinkage element in the clip of the gasket.

4. A method according to claim 3, for making a sealing gasket such as a top segment for a window run, in which the anti-shrinkage element is situated in the first limb of the clip that is the limb further from the sealing lip, and is positioned substantially in or on either side of a vertical plane containing the center of gravity of the right section of the gasket.

5. A method according to claim 3, for making a sealing gasket such as a top segment of a window run, in which the anti-shrinkage element is situated in the first limb of the clip and is positioned towards the right or towards the left of a vertical plane containing the center of gravity of the right section of the gasket.

6. A method according to claim 3, in which the shrinkage gradient of the various materials used for making the clip, the main leg, and the sealing lip at the end of the main leg decreases going from the clip towards the sealing lip.

7. A method according to claim 6, in which a material such as polypropylene is used for making the clip, a TPO is used for making the main leg, and a TPE is used for making the sealing lip.

8. A method according to claim 6, in which a material such as polypropylene is used for making the clip and the main leg, and a TPE is used for making the sealing lip.

9. A method according to claim 6, in which a material such as polypropylene is used for making the clip, and a TPE is used for making the main leg and the sealing lip.

10. A method according to claim 3, for making a vertical segment of a window run, in which the anti-shrinkage element is positioned at least in the web of the clip.

11. A method according to claim 9, in which the anti-shrinkage element is positioned in the web and in part in the secondary leg.

12. A method according to claim 1, in which the anti-shrinkage element is constituted by reinforcement or at least one metal wire or glass fiber.

13. A sealing gasket forming a hidden frame type window run, for example, the gasket comprising a mounting clip of U-shaped right section with first and second mutually parallel limbs, a main leg, and a secondary leg which extend perpendicularly from the second limb of the clip, and sealing lips towards the ends of said legs, and an anti-shrinkage element placed in the clip, and in which the thermoplastic materials used for making the gasket present a shrinkage gradient that decreases going from the clip towards the sealing lips.

14. A sealing gasket according to claim 13, in which the clip of the gasket is made of polypropylene, the main leg of the gasket is made of TPO, and the sealing lip at the end of the main leg is made of TPE.

15. A sealing gasket according to claim 13, in which the clip and the main leg of the gasket are made of polypropylene, and the sealing lip is made of TPE.

16. A sealing gasket according to claim 13, in which the clip is made of polypropylene, and the main leg and the sealing lip are made of TPE.

17. A sealing gasket forming a top segment of a hidden frame type window run according to claim 13, in which the anti-shrinkage element is situated in the first limb of the clip.

18. A sealing gasket forming a top segment of a hidden frame type window run according to claim 13, in which the anti-shrinkage element is situated in the web of the clip.

19. A sealing gasket according to claim 13, in which the anti-shrinkage element is constituted by reinforcement or by at least one metal wire or glass fiber.
